(19) United States
(12) Patent Application Publication
(10) Pub. No.: US 2020/0074419 A1
(43) Pub. Date: Mar. 5, 2020

(54) METHOD OF CONDUCTING A DIGITAL CURRENCY EXCHANGE TRANSACTION UTILIZING BLOCKCHAIN

(71) Applicant: VIO DIGITAL LTD, Port Louis (MU)

(72) Inventor: Pragasen GOVENDER, Johannesburg (ZA)

(21) Appl. No.: 16/116,315

(22) Filed: Aug. 29, 2018

(51) Int. Cl. G06Q 20/06; G06Q 20/10; G06Q 20/38; G06F 17/30

(52) U.S. Cl. CPC G06Q 20/065; G06F 17/30283; G06Q 20/381; G06Q 20/10

(57) ABSTRACT

This invention relates to a method of conducting a digital currency exchange transaction whereby a specified amount of a digital currency is to be converted to a fiat currency, the method including the steps of initiating, on a processing server, the digital currency exchange transaction; debiting a user's digital currency account with the specified amount of the digital currency; recording, on a blockchain, the debiting of the user's digital currency account; converting, via an exchange service provider, the debited digital currency to the fiat currency; and depositing, by means of a push payment transaction and via a payment network, the converted fiat currency into a designated receiver account that is associated with the payment network.

### FIELD OF THE INVENTION

This invention relates to a method of conducting a digital currency exchange transaction utilizing blockchain. More particularly, but not exclusively, this invention relates to a method of conducting a digital currency exchange transaction utilizing blockchain whereby a specified amount of a digital currency is to be converted to a fiat currency.

### BACKGROUND TO THE INVENTION

In many poor countries, remittances make up more than a quarter of national income.

Currently, it is relatively expensive to send money electronically across international borders, which is especially damaging for immigrants sending small amounts of savings home to the developing world. According to the World Bank, transaction fees average 7.5% globally, however, in many remittance corridors, it could be a lot higher. Sending money to Africa from the United States of America or Europe, for example, may cost an extra 15% in some instances, and within Africa, the transaction fees can be as high as 20% of the transacted amount.

One of the main reasons why the cost of sending money cross-border is currently so high is that most payments start and finish in cash. This process requires human agents to be employed to receive and disburse the money, thereby raising the transaction fees.

The advent of blockchain technology has enabled instant, secure and cost-effective transfer of funds between parties anywhere in the world. However, due to the requirement for local fiat currency by recipients, known methods and systems still rely on a costly corresponding receiving network for the conversion of digital currency to local currency (in cash).

In recent years, a few financial products have emerged that allow consumers to convert digital or non-fiat currency, such as cryptocurrency (e.g. Bitcoin, Ether, and the like), into fiat currency or legal tender, and to deposit those funds into a bank account which is linked to a payment network. However, bank transfers often take days to clear and have the funds available due to the batch nature of such fund transfers.

Payment networks do offer real-time push payment capabilities. Through a participating financial institution, businesses and consumers can use the payment network push payment to transfer funds to over a billion current payment card accounts. However, payment networks require that any digital currency (i.e. non-fiat currency) funds must be converted to a fiat currency before being deposited into a user's payment card or receiver account.

### OBJECT OF THE INVENTION

It is accordingly an object of the present invention to provide for a method of transferring funds between accounts, locally or internationally, in a safe, efficient and cost-effective manner.

### SUMMARY OF THE INVENTION

According to the invention, there is provided a method of conducting a digital currency exchange transaction whereby a specified amount of a digital currency is to be converted to a fiat currency, the method including the steps of:
initiating, on a processing server, the digital currency exchange transaction;
debiting a user's digital currency account with the specified amount of the digital currency;
recording, on a blockchain, the debiting of the user's digital currency account;
converting, via an exchange service provider, the debited digital currency to the fiat currency; and
depositing, by means of a push payment transaction and via a payment network, the converted fiat currency into a designated receiver account that is associated with the payment network.

The user's digital currency account may be caused to be debited by the processing server transmitting a debiting instruction.

The method may further include the step of transmitting, from a computing platform to the processing server, a transaction request to conduct the digital currency exchange transaction.

There is provided for the transaction request to be recorded on a blockchain.

According to an example embodiment of the invention, the processing server may, prior to initiating the digital currency exchange transaction, verify the identity of a user operating the computing platform against pre-stored identification data associated with the user's digital currency account.

The pre-stored identification data may be stored on the processing server.

There is provided for the user's digital currency account, to be debited, to be a digital currency e-wallet which is associated with a cryptocurrency.

There is also provided for the debited digital currency to be caused to be converted to the fiat currency by the processing server transmitting an exchange instruction to the exchange service provider.

The exchange instruction may be recorded on a blockchain.

A foreign exchange conversion may be applied to the fiat currency, prior to depositing same into the designated receiver account.

The push payment transaction via the payment network may be conducted between the exchange service provider and the designated receiver account.

According to an example embodiment, the push payment transaction via the payment network is submitted to an originating financial institution, the originating financial institution crediting the designated receiver account with the converted fiat currency.

These and other features of the invention are described in more detail below.

### BRIEF DESCRIPTION OF THE ACCOMPANYING DIAGRAMS

The present invention will now further be described, by way of example only, with reference to the accompanying drawings wherein:

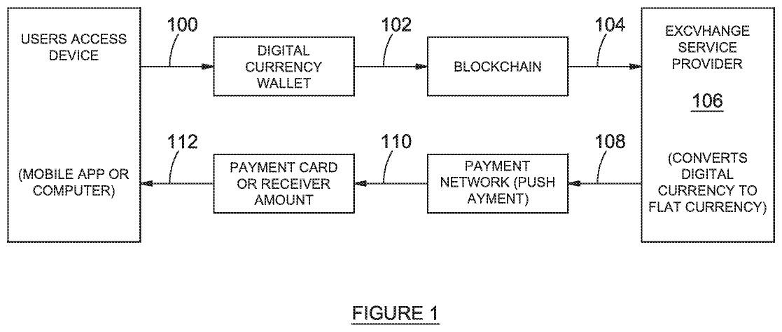

FIG. 1 is a block diagram illustrating a high-level method of conducting a digital currency exchange transaction according to a first exemplary embodiment of the invention; and

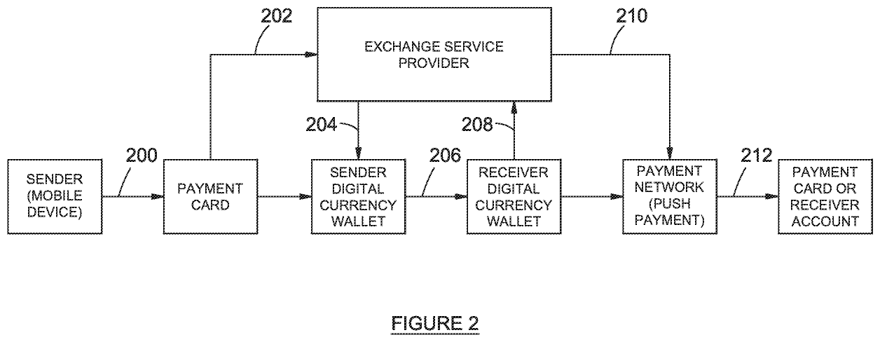

FIG. 2 is a block diagram illustrating a high-level method of conducting a digital currency exchange transaction according to a second exemplary

### DETAILED DESCRIPTION OF THE INVENTION

### Glossary to Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, cheques, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specified digital, virtual, fiat, flat, or another type of currency.

Digital currency—A virtual currency (also known as a digital currency) is a medium of exchange implemented through the Internet generally not tied to a specific government-backed “flat or fiat” currency such as the US dollar or the Euro and typically designed to allow instantaneous transactions and borderless transfer of ownership. A well-known type of virtual currency is cryptocurrency, in which cryptography is used to secure transactions and to control the creation of new units (i.e. units of cryptocurrency). Several cryptocurrencies exist, of which a well-known one is Bitcoin. Bitcoin is decentralised in the sense that it has no central point of control. Transactions are recorded on a public ledger in the form of a blockchain—a distributed database which maintains a continuously growing list of transaction data records. Cryptographic processes are used to harden the blockchain against tampering and revision. Decentralisation and a public ledger are typical features of cryptocurrencies.

Push payment—A push payment is a financial transaction that adds funds (in the form of a credit) to a designated payment network account. Push payments are available from payment networks in the form of, amongst others, Visa® Direct offered by Visa® or Mastercard® Send offered by Mastercard®. This push payment capability may be delivered using the Original Credit Transaction (OCT). An OCT is typically a clearing and settlement credit transaction designed for use in business applications such as a business money transfer or business-to-consumer repayments. When used in the context of the present invention (for money transfer), the push payment is the transaction used to deliver funds to a payment card or receiver account.

Exchange server provider—An exchange server provider may include or be associated with any party or entity which exchanges or converts funds in a transaction. In other cases, an exchange service provider may be a digital currency exchange server provider such as Coinbase, Binance or a bank or other party or entity which is not associated with a payment network. Primary Account Number (PAN)—A PAN may include any string, sequence of digits, or another identifier suitable to identify an account associated with a payment network. In some cases, PAN may include an issuer identification number, an individual account identifier, and a check digit.

Sending account—A sending account may include any account associated with a party sending funds in a transaction. For example, a sending account may be an account or wallet associated with a blockchain, such as a Bitcoin wallet or Ethereum wallet. In other cases, a sending account may be a digital currency exchange such as Coinbase, Binance or another account not associated with a payment network.

Receiver account—A receiver account may include any account associated with a recipient of funds in a transaction. In some cases, the receiver account may be an account associated with a payment network, such as a debit card account or an account associated with a payment token. In other cases, the receiver account may be a bank account or other account not associated with a payment network (e.g. a pre-paid account, a mobile account, e-wallet, etc.). For example, in some cases, the receiver account may not be associated with a PAN. The receiver account may be maintained by a recipient bank.

### User Profile Registration Process

A user (or customer) wanting to utilise the method of conducting a digital currency exchange transaction, according to the invention, and as will be elaborated on further below, first has to register a profile on a computing platform.

The registration process commences upon the user accessing the platform via a remote device. The platform may take the form of a mobile application or Internet page. The remote device can be any smart device including a personal computer, laptop, mobile phone, tablet, or the like.

Upon accessing the platform, the user registers a profile on the processing server. To complete the registration process, the user has to provide its full name(s), surname, identification number or social security number, mobile number, e-mail address, postal and/or home address and nationality. Finally, the user has to scan its identification document or social security card and submit an electronic copy of the same to the platform. Having received the scanned electronic copy of the user's identification document or social security card (i.e. pre-stored identification data stored on the processing server), the platform—whilst remaining in communication with the processing server—performs a digital verification step, upon receiving an instruction to do so from the processing server, whereby the user's face is scanned, in real time, by the remote device and compared to the picture on the identification card or social security card.

If the aforementioned facial verification step is successful (i.e. the picture on the user's identification card or social security card and the real-time face scan correspond to each other), the platform will cause a profile for the user to be created and saved on the processing server, and cause a newly created digital currency account on a blockchain to be linked to the user's profile. Alternatively, the user can link an existing digital currency account to the newly created profile. If the facial verification step is unsuccessful (i.e. the picture on the user's identification card or social security card and the real-time face scan do not correspond to each other), the user will be unable to complete the registration process.

The user may also link a payment card PAN or receiving account to its profile.

### First Exemplary Digital Currency Exchange Transaction

FIG. 1 shows a block diagram illustrating a high-level method of conducting a digital currency exchange transaction whereby a specified amount of digital currency is to be converted to a fiat currency, according to one example embodiment of the invention.

A user can load digital currency into a digital currency e-wallet by way of several methods, including: an exchange service provider using an e-wallet top-up method, purchase from a digital currency exchange, receive from other registered users of the platform (of the current invention), from a money transfer, or from a remittance.

As shown in FIG. 1, at step (100), a user submits a transaction request on a computing platform, being in communication with a processing server, to conduct the digital currency exchange transaction, which transaction is then initiated on the processing server.

At steps (102) and (104), the processing server transmits a debiting instruction whereby the user's digital currency e-wallet (associated with a cryptocurrency) is debited with the specified amount of the digital currency to be exchanged, and both the request, as submitted by the user, and the debit transaction is recorded on a blockchain. The request and debit transaction may be recorded as a single blockchain transaction, or as separate blockchain transactions. The blockchain may be either a permissioned blockchain or a public and decentralised blockchain.

At step (106), the exchange server provider, upon receiving an exchange instruction from the platform and/or processing server associated with the platform, converts the digital currency funds to a fiat currency. Here, the conversion of the digital currency into a fiat currency will be carried out in accordance with the applicable laws of the country whose fiat currency the digital currency is converted to. The exchange instruction is recorded on a blockchain. The exchange instruction may be recorded along with the transaction request and/or debit transaction as a single blockchain transaction, or it may be recorded as a separate blockchain transaction. Again, the blockchain may be either a permissioned blockchain or a public and decentralised blockchain.

Step (106) may include an additional step whereby the exchange service provider applies a foreign exchange conversion if the fiat currency (to which the digital currency has been converted to) is not the same as the settlement fiat currency.

At step (108), the exchange service provider submits a push payment transaction to a payment network, via an originating financial institution, to deposit the converted fiat currency directly into a designated receiver account that is associated with the payment network, in this example being the user's receiver account.

At step (110), the payment network deposits the converted local fiat currency into the user's receiver account using a push payment via an originating financial institution.

At step (112), the user can view the updated digital currency balance in their digital currency wallet.

It is important to note that this invention does not issue a separate digital currency payment card. Rather, the invention leverages blockchain technology and payment network technology in the form of push payment to provide users with a simpler and more convenient way to move funds from their digital currency account to a fiat currency account.

### Second Exemplary Digital Currency Exchange Transaction

FIG. 2 shows a block diagram illustrating a high-level method of conducting a digital currency exchange transaction whereby a specified amount of digital currency is to be converted to a fiat currency, according to another example embodiment of the invention.

At steps (200), (202) and (204) a sender (i.e. user) can load digital currency onto its digital currency e-wallet from an exchange service provider, by a wallet top-up, etc.

At step (206), the sender transfers digital currency to a recipient (i.e. receiver) via a blockchain transaction (domestically or internationally, either to another profile or wallet address). The sender's digital currency wallet is debited, the recipient's digital currency wallet is credited and the transaction is recorded on the blockchain.

At step (208), the recipient submits a digital currency exchange transaction request on the computing platform, being in communication with the processing server which hosts and/or manages the method of conducting a digital currency exchange transaction, to exchange the specified amount of digital currency to a local fiat currency. The transaction is then initiated on the processing server.

The processing server transmits a debiting instruction whereby the recipient's digital currency e-wallet (associated with a cryptocurrency) is debited with the specified amount of the digital currency to be exchanged, and both the request, as submitted by the recipient, and the debit transaction is recorded on a blockchain. The request and debit transaction may be recorded as a single blockchain transaction, or as separate blockchain transactions. The blockchain may be either a permissioned blockchain or a public and decentralised blockchain.

The exchange server provider, upon receiving an exchange instruction from the platform and/or processing server associated with the platform, converts the specified amount of digital currency into fiat currency. Here, the conversion of the digital currency into a fiat currency will be carried out in accordance with the applicable laws of the country whose fiat currency the digital currency is converted to. The exchange instruction is recorded on a blockchain. The exchange instruction may be recorded along with the transaction request and/or debit transaction as a single blockchain transaction, or it may be recorded as a separate blockchain transaction. Again, the blockchain may be either a permissioned blockchain or a public and decentralised blockchain.

Step (208) may include an additional step whereby the exchange service provider applies a foreign exchange conversion if the fiat currency (to which the digital currency has been converted to) is not the same as the settlement fiat currency. At step (210), the exchange service provider submits a push payment transaction to the payment network via an originating financial institution, to credit the recipient's receiver account.

At step (212), the payment network disburses the local fiat currency funds (having been converted from digital currency) into the recipient's receiver account using a push payment via an originating financial institution.

In this embodiment of the invention, the sender's digital currency wallet is used as the source of funds (to be transferred), and these funds can be sent from anywhere in the world using a blockchain (according to the invention), so long as there is an online connection. Furthermore, the recipient (or receiver) can receive the aforementioned funds in their receiver account, irrespective of where they may be.

It will be appreciated by those skilled in the art that this invention is not limited to the precise details as described herein and that many variations are possible without departing from the scope of the invention.

It will further be appreciated that the foregoing examples have been provided merely for the purposes of explanation and are in no way to be construed as limiting of the present invention. While the present invention has been described with reference to exemplary embodiments only, it is understood that the words which have been used herein are words of description and illustration, rather than words of limitation. The present invention is also not intended to be limited to the particulars disclosed herein. Rather, the present invention extends to all functionally equivalent structures, methods and uses, such as are within the scope of the invention.

1. A method of conducting a digital currency exchange transaction whereby a specified amount of a digital currency is to be converted to a fiat currency, the method including the steps of:
initiating, on a processing server, the digital currency exchange transaction;
debiting a user's digital currency account with the specified amount of the digital currency;
recording, on a blockchain, the debiting of the user's digital currency account;
converting, via an exchange service provider, the debited digital currency to the fiat currency; and
depositing, by means of a push payment transaction and via a payment network, the converted fiat currency into a designated receiver account that is associated with the payment network.

2. The method of claim 1, whereby the user's digital currency account is caused to be debited by the processing server transmitting a debiting instruction.

3. The method of claim 1, including transmitting, from a computing platform to the processing server, a transaction request to conduct the digital currency exchange transaction.

4. The method of claim 3, wherein the transaction request is recorded on a blockchain.

5. The method of claim 3, wherein the processing server, prior to initiating the digital currency exchange transaction, verifies the identity of a user operating the computing platform against pre-stored identification data associated with the user's digital currency account.

6. The method of claim 5, wherein the pre-stored identification data is stored on the processing server.

7. The method of claim 1, wherein the user's digital currency account, to be debited, is a digital currency e-wallet which is associated with a cryptocurrency.

8. The method of claim 1, whereby the debited digital currency is caused to be converted to the fiat currency by the processing server transmitting an exchange instruction to the exchange service provider.

9. The method of claim 8, wherein the exchange instruction is recorded on a blockchain.

10. The method of claim 1, including applying a foreign exchange conversion to the fiat currency, prior to depositing same into the designated receiver account.

11. The method of claim 1, wherein the push payment transaction via the payment network is conducted between the exchange service provider and the designated receiver account.

12. The method of claim 1, wherein the push payment transaction via the payment network is submitted to an originating financial institution, the originating financial institution crediting the designated receiver account with the converted fiat currency.
